(19) United States
(12) Patent Application Publication
(10) Pub. No.: US 2026/0057603 A1
(43) Pub. Date: Feb. 26, 2026

(54) OBJECT SEARCH USING RAY TRACING HARDWARE

(71) Applicant: Advanced Micro Devices, Inc., Santa Clara, CA (US)

(72) Inventor: Andrew Erin Kensler, Bellevue, WA (US)

(73) Assignee: Advanced Micro Devices, Inc., Santa Clara, CA (US)

(21) Appl. No.: 18/999,782

(22) Filed: Dec. 23, 2024

Related U.S. Application Data
(60) Provisional application No. 63/685,677, filed on Aug. 21, 2024.

(51) Int. Cl. G06T 15/06; G06T 15/80

(52) U.S. Cl. CPC G06T 15/06; G06T 15/80

(57) ABSTRACT

It is often desirable to perform a search for objects in a scene. Specifically, it is useful to determine whether objects are located within a search area and/or to identify the nearest objects to a search point. Ray tracing systems have capabilities that are nearly sufficient to perform such a search. For instance, ray tracing systems build acceleration structures such as bounding volume hierarchies (“BVHs”) that help to accelerate the evaluation of a ray. These BVHs are also useful for performing object searches. Ray tracing hardware includes functionality related to performing a ray-box test, which can be adapted for searching whether an object is within a search area. Ray tracing hardware also includes functionality related to instances. In ray tracing, instances are copies of geometry, with an instance transform (e.g., scale, shear, rotation) applied. As objects being searched for may be instances, the instance-related functionality is useful for object searching.

### CROSS REFERENCE TO RELATED APPLICATIONS

This application claims priority to pending U.S. Provisional Patent Application No. 63/685,677, filed on Aug. 21, 2024, the entirety of which is hereby incorporated herein by reference.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5A illustrates operations for performing a query to identify geometry objects within an area;

FIG. 5B illustrates additional operations for performing the search;

FIG. 6 illustrates a distance metric used by the range query engine and returned to the shader core, according to an example;

FIG. 7 illustrates example geometry for instance nodes;

FIG. 8 illustrates a search area;

FIG. 9 illustrates a search area in an instance-local coordinate system;

FIG. 10 illustrates operations for updating a search area; and

FIG. 11 illustrates a method for searching for objects within a search area.

### DETAILED DESCRIPTION

It is often desirable to perform a search for objects in a scene. Specifically, it is useful to determine whether objects are located within a search area and/or to identify the nearest objects (e.g., the k-nearest objects) to a search point.

Ray tracing systems have capabilities that are nearly sufficient to perform such a search. For instance, ray tracing systems build acceleration structures such as bounding volume hierarchies (“BVHs”) that help to accelerate the evaluation of a ray (e.g., for intersection with objects of a scene). These BVHs are also useful for performing object searches.

In addition, ray tracing hardware includes functionality related to performing a ray-box test. Ray-box tests test for whether rays intersect an axis-aligned bounding box, which is useful to eliminate portions of a BVH from consideration. Such functionality is adapted in a straightforward manner to calculate the distance from a search point to an object, in order to identify the closest objects to a search point. To perform such calculation using the ray-box hardware, a special sort of distance metric—the Chebyshev metric—is used.

In addition, ray tracing hardware includes functionality related to instances. In ray tracing, instances are copies of geometry, with an instance transform (e.g., scale, shear, rotation) applied. As objects being searched for may be instances, the instance-related functionality is useful for object searching as well.

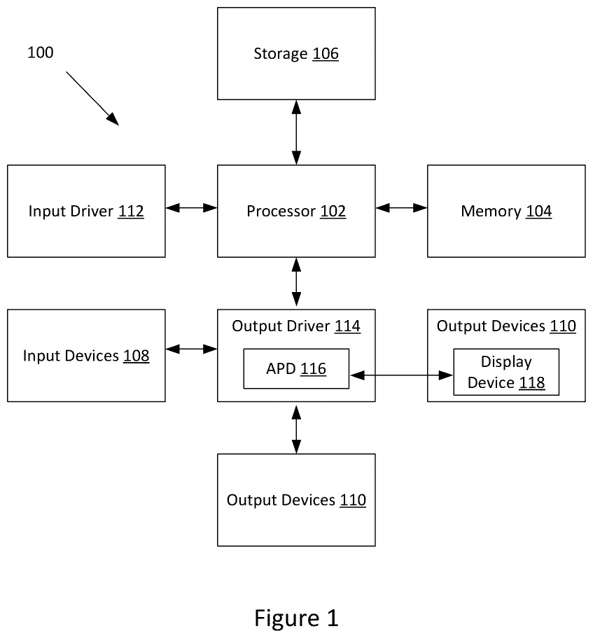

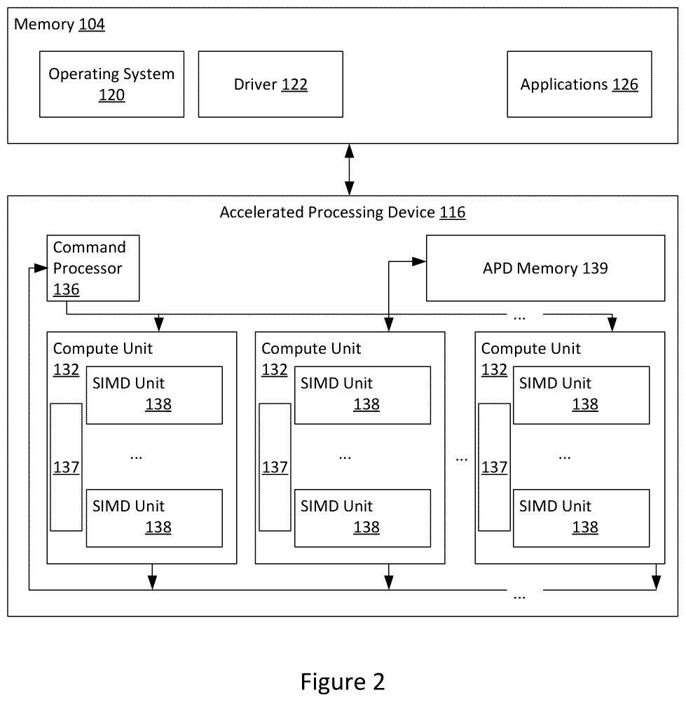

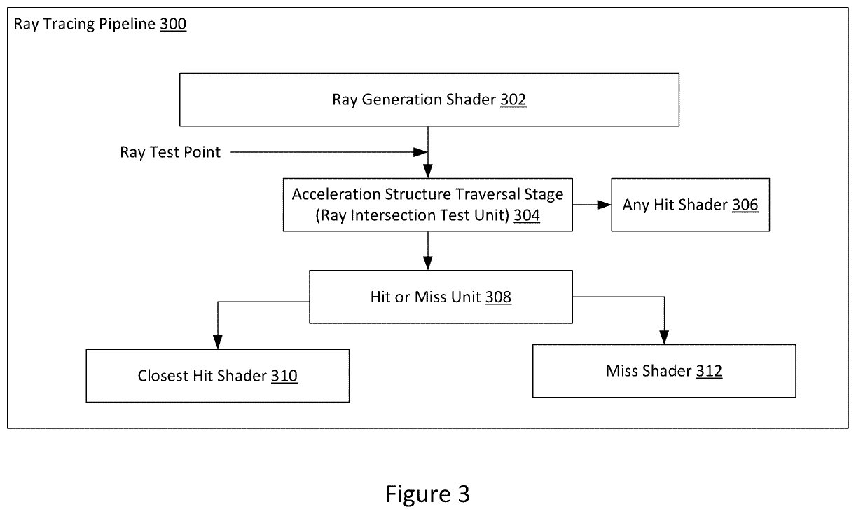

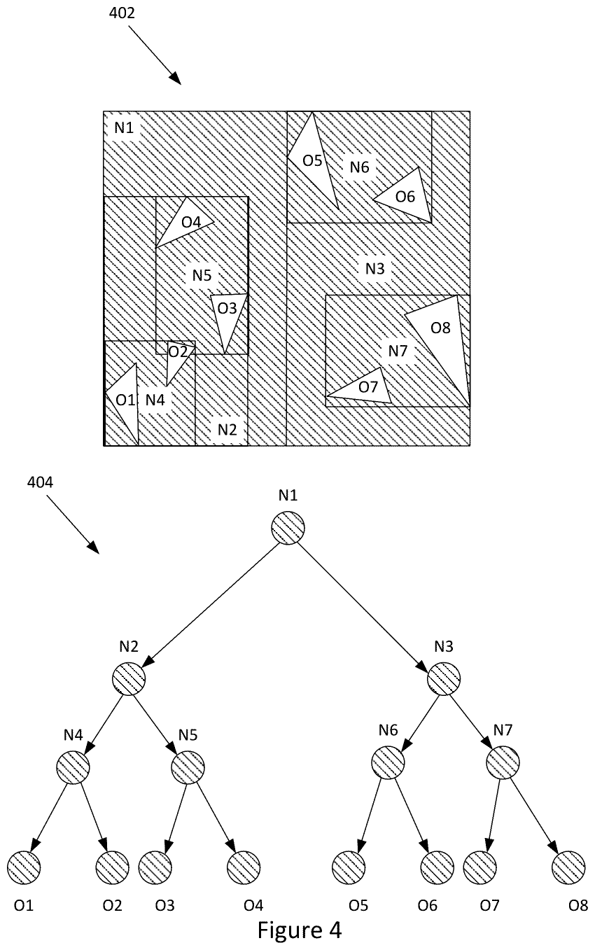

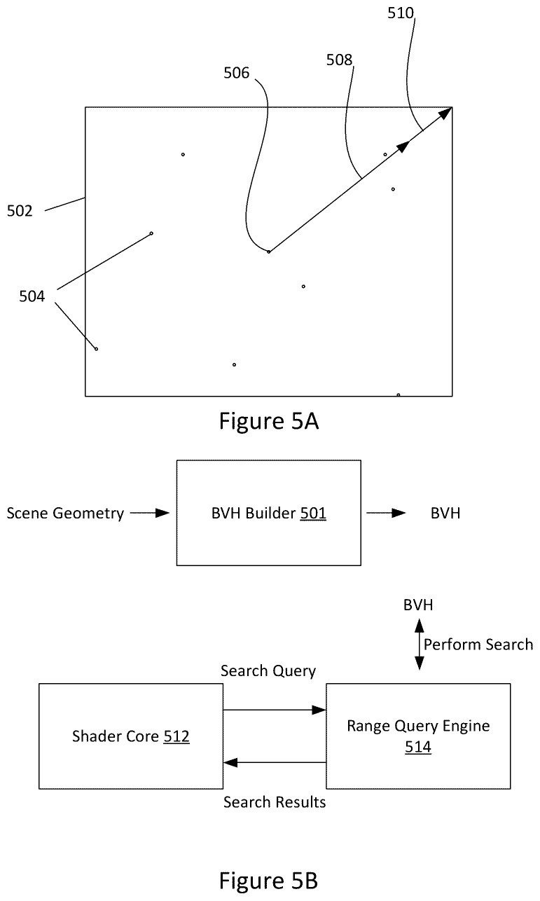

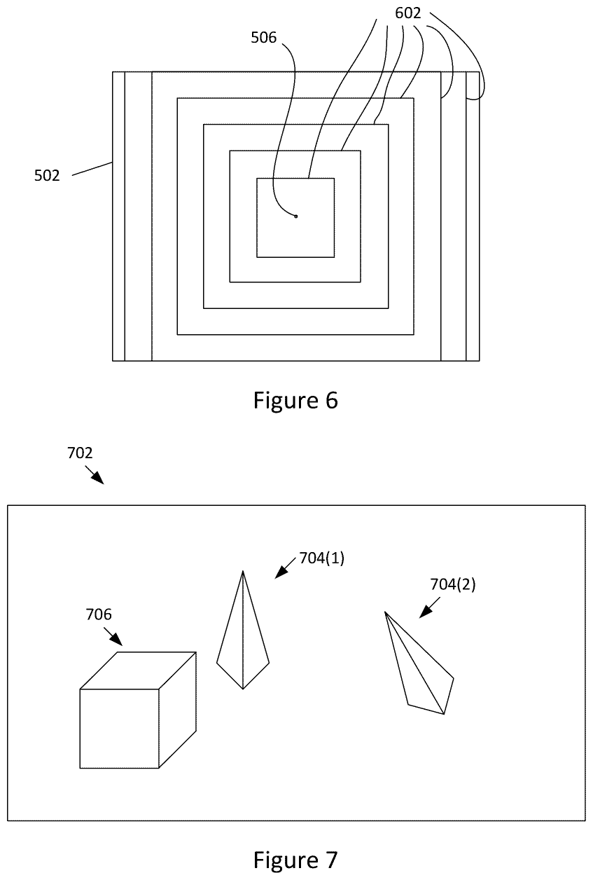

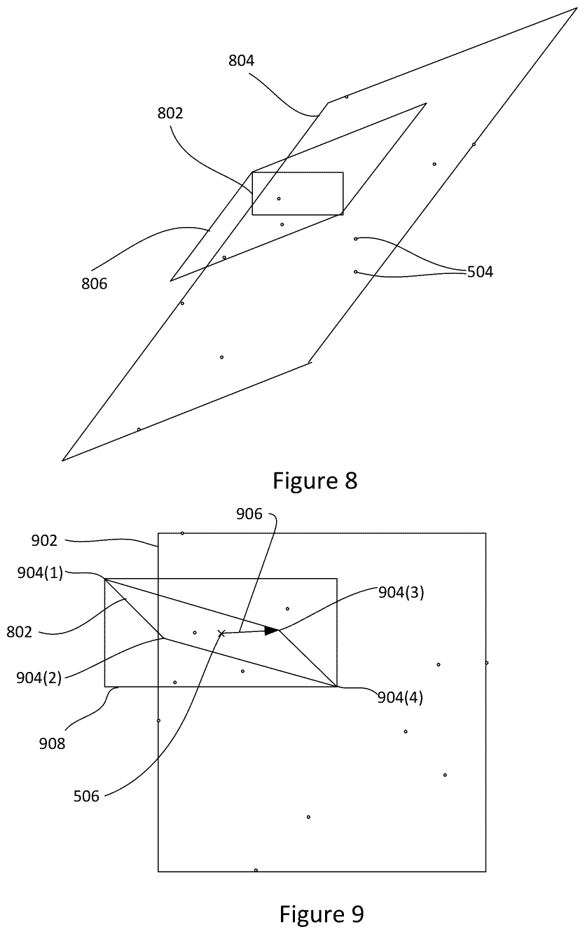

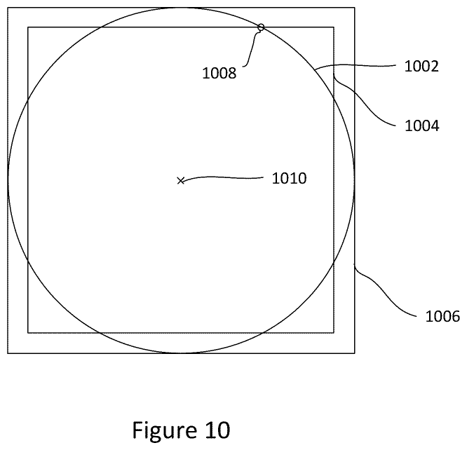

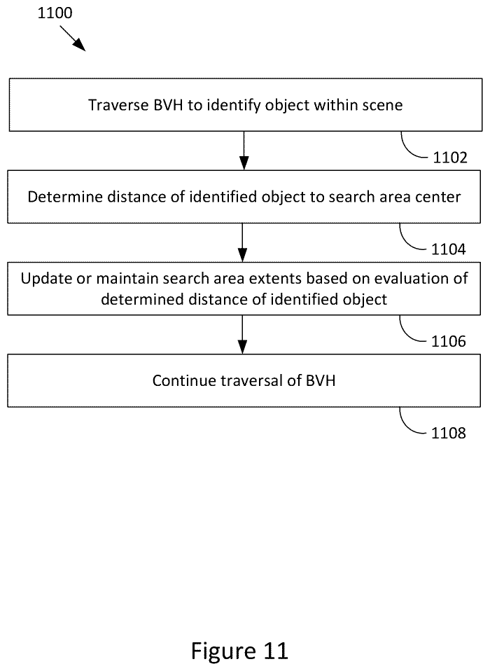

In summary, it is relatively straightforward to adapt ray tracing hardware for use in performing searches. FIGS. 1 and 2 illustrate hardware on which the techniques of the present disclosure can be performed. FIGS. 3 and 4 illustrate concepts related to ray tracing. FIGS. 5A and 5B illustrate operations for performing a search for objects. FIG. 6 illustrates the Chebyshev distance metric. FIG. 7 illustrates instanced objects. FIGS. 8 and 9 illustrate techniques related to instance transforms. FIG. 10 illustrates techniques related to narrowing the area of search as new objects are found. FIG. 11 illustrates a method for performing a search for objects within a search area.

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A command processor 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the command processor 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles or other types of primitives (e.g., procedural primitives).

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential distance to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, with each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point or at a different point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis-aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

In some instances, it is desirable to perform a query to identify geometric objects within a particular area. Such a query can be performed using a slightly modified version of hardware used for ray tracing. FIG. 5A illustrates operations for performing a query to identify geometry objects within an area. Specifically, in FIG. 5A, a search is performed to find objects (e.g., points) 504 within a search area 502 of a scene. The scene contains geometry specified by vertex attributes, primitive identifiers, mesh identifiers, and other information. The search area 502 is an area defined by a center point 506, an extent 508, and, optionally, a scaling factor 510. The center 506 and extent 508 define an axis aligned bounding box, where the extent defines the distance from the center 506 to a corner of the axis aligned bounding box. The scaling factor 510, if present, is an additional scaling factor to the size of the box that increases or decreases the size of the box generated by the center 506 and extent 508. The search searches for objects 504 within the search area 502.

FIG. 5B illustrates additional operations for performing the search. A BVH builder 501 builds a BVH based on scene geometry. The BVH builder 501 is implemented in any technically feasible manner, such as software executing on the processor 102 and/or APD 116, as hardware (e.g., digital circuitry) configured to perform operations described herein, or as a combination thereof. There are a variety of known techniques for building a BVH based on scene geometry. In some examples, the BVH is already built for ray tracing operations and the search query simply uses the BVH built for the ray tracing operations.

A shader core 512 cooperates with a range query engine 514 to perform a search for objects 504 within a search area 502 of a scene. The shader core 512 is a programmable processor such as a SIMD unit 138 that executes computer instructions (for example in a SIMD manner). The range query engine 514 comprises digital circuitry configured to perform the operations described herein. In some examples, the shader core 512 executes a “search area instruction,” which is a request to perform a search for objects 504 within a search area 502. This request is transmitted to the range query engine 514 (e.g., shown as the search query). The range query engine 514 performs a search using the BVH and provides search results to the range query engine 514. To perform a search, the range query engine 514 traverses the BVH, starting at a root node and continuing down. In some examples, the objects 504 being searched for are represented as leaf nodes. In some examples, such objects 504 are represented as procedural primitives. A procedural primitive is a primitive defined in a leaf node, where the determination of whether a ray intersects the procedural primitive is made by executing an intersection shader. In some examples, traversing the BVH to find the objects includes, for each non-leaf node encountered, determining whether the bounding volume of the non-leaf node is within the search area 502. If a bounding volume is not included in the search area, then the range query engine 514 does not traverse to the children of the non-leaf node corresponding to that bounding volume. If a bounding volume is included, then the range query search engine 514 does traverse to the children of that non-leaf node.

In some examples, when the range query engine 514 arrives at a leaf node and determines that the leaf node is within the search area 502, the range query engine 514 returns an indication that the leaf node is within the search area 502 to the shader core 512. In some examples, this results in a shader invocation for a procedural primitive shader or for a different type of shader. The shader core 512 processes this result and, optionally, provides an updated or new search to the range query engine 514. In some examples, the shader core 512 reduces the search area 502 based on the search results and provides this reduced search area to the range query engine 514 to continue its search. In some examples, this continuation searches through the remainder of the BVH (e.g., the BVH nodes not yet traversed to) to determine whether leaf node geometry is within the updated search area. In some examples, the shader core 512 updates the search area from a larger search area to a smaller search area based on the fact that the objects 504 being searched for are guaranteed to be within the smaller search area, and thus searching within the larger search area would represented wasted effort. In an example, the shader core 512 is searching for k (e.g., 8) nearest neighbors (e.g., objects 504) to a point (the center 506 of the search area 502). In the event that the range query engine 514 provides k objects 504 to the shader core 512, the shader core 512 knows that the farthest out that one of the k nearest neighbors can be to the point is the distance of the farthest point already returned to the shader core 512. Thus, the shader core 512 is able to return the updated range to the range query engine 514 in response to the search results, in order to improve the performance of the subsequent search. Note that in some examples, providing this updated range results in the range query engine 514 continuing to traverse the BVH from the point in the BVH when the range query engine 514 provided the search results to the shader core 512. In other words, the range query engine 514 continues where it left off when it provided the search results to the shader core 512.

FIG. 6 illustrates a distance metric used by the range query engine 514 and returned to the shader core 512, according to an example. The distance metric is a value that characterizes the distance of an object 504 to the center 506 of the search area 502. In some examples, the distance metric is the L-infinity metric (also called the Chebyshev distance). According to this distance metric, a distance is characterized as the maximum of the absolute value of the distance from an object to a center in each of three dimensions. In other words, the distance is max (|Δx|, |Δy|, |Δz|), where “max” is the maximum function that selects the highest of its parameters, and ΔD is the difference between the value of the center and the value of the object 504 in the D-axis (where D can be x, y, or z). In some examples, one or more of these delta values is scaled by some value before taking the max and the scales may be unequal for x, y, and z. This corresponds to the scaling by the box half-extents. For example, if the center has coordinates 0, 0, 0, and an object has coordinates −1, 2, −4, then the distance metric would be 4, as this is the largest axis-distance, (x has distance 1, y has distance 2, and z has distance 4).

This distance metric is illustrated in FIG. 6. Specifically, the center point 506 and search area 502 from FIG. 5A are illustrated, and in addition, lines of equal distance 602 are illustrated. Using a Euclidean distance metric, the lines of equal distance would be circles in 2D (spheres in 3D) but with the Chebyshev distance metric, the lines of equal distance are rectangles. It should be understood that, on the lines of equal distance 602, the distance to the center point 506 according to the Chebyshev distance is equal.

In some examples, the range query engine 514 calculates the Chebyshev distance with operations that are functionally equivalent to the following pseudo-code:

```
queryBoxBox(vec3 queryCenter, vec3 queryExtents, vec3 box Min, vec3 boxMax)
{
  minPlanes = (boxMin − queryCenter) / queryExtents;
  maxPlanes = (boxMax − queryCenter) / queryExtents;
  if (abs(minPlanes.x) > abs(maxPlanes.x)) swap(minPlanes.x, maxPlanes.x);
  if (abs(minPlanes.y) > abs(maxPlanes.y)) swap(minPlanes.y, maxPlanes.y);
  if (abs(minPlanes.z) > abs(maxPlanes.z)) swap(minPlanes.z, maxPlanes.z);
  if (signbit(minPlanes.x) != signbit(maxPlanes.x)) minPlanes.x = 0;
  if (signbit(minPlanes.y) != signbit(maxPlanes.y)) minPlanes.y = 0;
  if (signbit(minPlanes.z) != signbit(maxPlanes.z)) minPlanes.z = 0;
  near = fmax(abs(minPlanes.x), abs(minPlanes.y), abs(minPlanes.z));
  far = fmax(abs(maxPlanes.x), abs(maxPlanes.y), abs(maxPlanes.z));
  return (near, far);
}
```

In the above code, the function queryBoxBox is a function to query the presence of objects, where the query is provided with a queryCenter (e.g., search area center 506) and queryExtents, which is a vector that defines the half-extents of the search area 502. In other words, the vector includes a value for each axis. This value is half of the length of the search area axis-aligned bounding box in that corresponding axis. The box extends from the center minus that half value to the center plus that half value, for each axis. boxMin and boxMax are the coordinates that define the axis-aligned bounding box of an object 504 that is being tested for inclusion in the search area. In other words, boxMin is the minimum coordinate for the box and boxMax is the maximum coordinate-together, these values define corners on a diagonal that spans the box extents, thereby defining the box.

The pseudo code calculates the “near” and “far” values, which are the Chebyshev distance metrics for the point on the object's box that is closest to the center (“near”) and the point on the object's box that is farthest from the center (“far”). The first two lines of the pseudo-code normalize the box coordinates to the query box: (boxMin−queryCenter)/queryExtents calculates the ratio of the distance to the object's box “min” point to the extent of the search area, and the second line calculates this for “maxPlanes.” The next three if statements swap “min planes” and “max planes” to account for the situation where the box is located at a coordinate value that is lower than the coordinates of the center of the search area. For example, the “min” value would actually be greater than the “max” value initially if the object's box has coordinate values that are lower than those of the search area center, since the minimum point on the object box would be farther away from the search area center than the maximum point on the object box.

The next two if statements check if the sign of the min and max planes are different, which would be the case if the object's box spans the query center. If so, the distance metric is 0, since the object's box overlaps the query center. Finally, the assignment to near and far values simply assigns the Chebyshev metric—the maximum of the min and max planes—to the near and far variables, which are returned as values characterizing the distance of the object's box to the center of the search area.

The follow pseudo-code represents operations for determining the intersection point between a ray and a bounding box, which would be used for ray tracing (e.g., to determine whether a ray intersects the bounding volume of a node):

```
rayBox(vec3 rayOrigin, vec3 rayDirection, vec3 boxMin, vec3 boxMax)
{
  minPlanes = (boxMin − rayOrigin) / rayDirection;
  maxPlanes = (boxMax − rayOrigin) / rayDirection;
  if (minPlanes.x > maxPlanes.x) swap(minPlanes.x, maxPlanes.x);
  if (minPlanes.y > maxPlanes.y) swap(minPlanes.y, maxPlanes.y);
  if (minPlanes.z > maxPlanes.z) swap(minPlanes.z, maxPlanes.z);
  near = fmax(minPlanes.x, minPlanes.y, minPlanes.z);
  far = fmin(maxPlanes.x, maxPlanes.y, maxPlanes.z);
  return (near, far);
}
```

In this pseudo-code, minPlanes and maxPlanes are calculated in a similar manner as above, and these values are also swapped also in a similar manner except that the absolute values of the minPlanes and maxPlanes values are not calculated. The minPlanes and maxPlanes are not set to 0, and the far value is calculated as the minimum of the maxPlanes vector components. This pseudo-code represents operations for the “slabs” style of ray-box intersection test. It treats the box as the intersection of three infinite slabs sandwiched between axis-aligned planes (i.e., one slab for x, y, and z). The intersection of the intervals of the t-values with each plane gives the interval of the intersection with the box. In terms of ray tracing, the ‘near’ and ‘far’ values are the t-values where the ray enters and leaves the box. They may be behind the ray if ‘far’ is negative, or beyond the current length of the ray if ‘near’ is greater than the ray's tmax. In either of those cases, there is no ray intersection. The differences between this ray box intersection test the computation of the Chebyshev distances to the box represent minor differences that could easily be implemented in hardware, with reuse of the common operations between the ray tracing box intersection test and the search. In some examples, the three lines that check whether the minPlanes.C (where “C” means “coordinate axis”) is greater than maxPlanes. C are replaced with lines that check whether the sign bit of the ray direction in that coordinate axis is 0 or 1. If the sign bit is 1 (meaning the sign is positive—the ray points in a positive direction in that coordinate axis), then the ray direction is moving positively in that axis, in which case the planes are swapped. In another example, instead of dividing by the ray direction (or query extents) to get min and max, the reciprocal of the ray direction or query extents is pre-computed, and the result is multiplied by the boxMin—rayOrigin.

It is possible to use only the “near” distance, referred to sometimes herein as the “half ray/box intersection testers.” In some such examples, the following pseudo-code is used:

```
halfRayBox(vec3 rayOrigin, vec3 invRayDirection, vec3 boxMin, vec3 boxMax)
{
  vec3 minPlanes = (boxMin − rayOrigin) * invRayDirection;
  vec3 maxPlanes = (boxMax − rayOrigin) * invRayDirection;
  float nearX = signbit(invRayDirection.x) ? maxPlanes.x : minPlanes.x;
  float nearY = signbit(invRayDirection.y) ? maxPlanes.y : minPlanes.y;
  float nearZ = signbit(invRayDirection.z) ? maxPlanes.z : minPlanes.z;
  float near = fmax(nearX, nearY, nearZ);
  return near;
}
```

The half box-box distance is as follows in the above scenario:

```
halfQueryBoxBox(vec3 queryCenter, vec3 invQueryExtents, vec3 boxMin, vec3 boxMax)
{
  vec3 minPlanes = (boxMin − queryCenter) * invQueryExtents;
  vec3 maxPlanes = (boxMax − queryCenter) * invQueryExtents;
    float nearX = signbit(minPlanes.x) && signbit(maxPlanes.x) ? maxPlanes.x :
      !signbit(minPlanes.x) && !signbit(maxPlanes.x) ? minPlanes.x : 0.0f;
    float nearY = signbit(minPlanes.y) && signbit(maxPlanes.y) ? maxPlanes.y :
      !signbit(minPlanes.y) && !signbit(maxPlanes.y) ? minPlanes.y : 0.0f;
    float nearZ = signbit(invQueryExtentsminPlanes.z) && signbit(maxPlanes.z) ?
      maxPlanes.z : !signbit(minPlanes.z) && !signbit(maxPlanes.z) ?
      minPlanes.z : 0.0f;
    float near = fmax(nearX, nearY, nearZ);
    return near;
}
```

Some scenes include instance geometry. Instance geometry is geometry whose vertex data is represented in an instance-local coordinate system that is transformed with respect to the world coordinate system (e.g., the base coordinate system of the BVH). The transform is specified in an instance node of the BVH, and specifies a rotation, scaling, translation, and shear. FIG. 7 illustrates example geometry for instance nodes. Specifically, in the scene 702, there are two instanced objects 704 that have corresponding instance nodes. However, while the mesh topology is the same, the instance transform for instance object 704(1) is different than that for instance object 704(2). Object 706 does not have an instance transform applied.

One issue with instance objects is that the coordinates of objects within the portion of the BVH associated with an instance are not in the same space as the coordinates of the box node specified for the search, which is in the base world space coordinates. This means that in order to perform the search, the box specified for the search query needs to be transformed in some manner so that the calculations for determining whether objects of an instance are included within the search area 502. In other words, when the range query engine 514 encounters an instance node while traversing the BVH, the range query engine 514 must generate a new, transformed box so that the math for the test of inclusion works in the coordinate space of the transform. To do this, the min and max coordinates specifying the box are transformed using the instance transform, and the resulting box is axis-aligned in the local coordinate space of the instance transform. FIGS. 8-9 illustrate this concept.

In FIG. 8, a search area 802 is illustrated. This search area 802 is specified in the world coordinate system. A transformed instance coordinate system 804 is also shown. The image illustrated is in the world coordinate system, where the initially specified search area 802 is axis-aligned. A corresponding search area 806 in the instance coordinate system is also shown. FIG. 9 illustrates the same items but in the instance coordinate system 902. As can be seen, the original search area 802 in the instance coordinate system is distorted and not axis-aligned. Further, the search area 802 has corners 904 in the instance coordinate system 902. To obtain a search area 908 in the instance coordinate system that is axis aligned and that is guaranteed to include all objects within the original search area 802, the range query engine 514 selects the corners 904 of the search area 802 that are farthest from the center 506. These corners become the corners of the axis-aligned search area in the transformed instance coordinate system 902. In the example shown, these corners are 904(1) and 904(4). Note that the value of the extents defined by these corners is different than the original extent 906 specified for the search area 802, which is much closer to the center 506. If such original extent 906 was used, the resulting axis-aligned bounding box could be smaller than the search area 802 and thus might not include all objects 504 being searched for. It is possible to use these transforms for box nodes as well as leaf nodes (e.g., procedural primitives)—any bounding volume of a BVH.

The following pseudo code illustrates example operations for transforming a search area from world coordinates to instance coordinates:

```
transformQueryBox(mat4x3 transform, vec3 queryCenter, vec3 queryExtents)
{
  localCenter = transform * vec4(queryCenter, 1);
  localExtents = mat3(
    abs(transform[0][0]), abs(transform[0][1]), abs(transform[0][2]),
    abs(transform[1][0]), abs(transform[1][1]), abs(transform[1][2]),
    abs(transform[2][0]), abs(transform[2][1]), abs(transform[2][2])) * queryExtents;
  return (localCenter, localExtents);
}
```

In this example, the transform is the instance transform and the queryCenter and queryExtents define the search area in the world coordinates. The function multiplies the transform by the queryCenter to obtain the instance local center. The local extents are defined as a matrix including the elements listed-absolute values of components of the transform, where this matrix is the multiplied by the input query extents. The result is the transformed center and extents, which are returned.

```
transform Ray(mat4x3 transform, vec3 rayOrigin, vec3 rayDirection)
{
  localOrigin = transform * vec4(rayOrigin, 1);
  localDirection = mat3(transform) * rayDirection;
  return (localOrigin, localDirection);
}
```

The transformQueryBox is similar to transformRay, which is used to transform a ray for BVH traversal into an instance node. The difference is just that the transform components are all made positive for transformQueryBox. This can be done using simple hardware to change sign, with the other hardware being shared between the ray transform and query box transform. Note that the signs are preserved when transforming the center.

FIG. 10 illustrates techniques for narrowing the search area as new objects are found. As stated above, after performing the search described above, the range query engine 514 returns the near and far distance to a found object, to the shader core 512. As also stated above, it is possible for the shader core 512 to reduce the size of the search area after receiving these results. However, care must be taken in comparing the near and far distances received to the size of the search area maintained by the shader core 512. Specifically, each object that is found in the search has a Chebyshev metric distance and a Euclidean (“normal”) distance, where these distances are from the center of the search area to the object. The shader core 512 can compare either such metric for the object to that of the search area extents, and then, if the metric of the object is lower than that of the extents, to adjust the search area extents to either the Euclidean distance of the found object or the Chebyshev distance of the found object. However, one combination of operations is not correct.

Specifically, it is possible to compare the Euclidean distance of the returned value to that of the extents of the search area and reduce the box to the Euclidean distance of the returned value if necessary. This is illustrated in FIG. 10, where the circle 1002 represents the Euclidean distance from point 1010 and the squares (small square 1004 and large square 1006) represent Chebyshev distances from point 1010. In FIG. 10, the point found 1008 has a Euclidean distance represented by the circle, and the initial search area's extents are set to bound the circle of the Euclidean distance (the outer square). In an example, the Euclidean distance of the object 1008 is compared against the search area distance and, if the Euclidean distance is less than the search area distance, then the updated search area is set to the Euclidean distance of the object 1008. This is satisfactory, as the outer square bounds all objects having a maximum of the Euclidean distance of the found object. Another technique is to compare the returned Chebyshev distance to the Chebyshev distance of the search area and reduce the search area to the Chebyshev distance of the returned value. In this situation, the search area would be reduced in size to a box whose extents lie on the returned value (square 1004). This is also satisfactory, since the search area is defined by Chebyshev distance. However, it is not possible to select the closest value by Euclidean distance and reduce the search area to the Chebyshev distance of the selected closest value. Specifically, the comparison is of the larger box (value defining the search area extents) to the circle (Euclidean distance of the found object). As can be seen, if the found object had a value that placed it within the larger box, then if the search area extents were updated to the Chebyshev distance of the found area—the smaller box—then this smaller box could miss objects that are farther than the found object by the Euclidean metric.

It should be understood that although many concepts are shown in 2D for simplicity, those concepts are understood to be implemented in 3D space.

FIG. 11 is a flow diagram of a method 1100 for performing a search, according to an example. Although described with respect to the systems of FIGS. 1-11, those of skill in the art will understand that any system configured to perform the steps of the method 1100 in any technically feasible order falls within the scope of the present disclosure.

At step 1102, a range query engine 514 traverses a BVH (e.g., at the request of a shader core 512) for a search area specified by the shader core 512. The search area specifies a center and an extents. The traversal involves proceeding through a BVH and determining whether bounding volumes associated with encountered nodes are within a search area. For nodes not included in the search area, the range query engine 514 does not further consider that node or children/descendants of that node. For nodes included in the search area, the range query engine 514 continues traversing to children/descendants of that node. Thus, in this example, the range query engine 514 traverses to a child of a node that is determined to be within the search area. Such a child can be a non-leaf node or a leaf node. In some examples, the range query engine 514 determines whether a bounding volume for either a leaf node or a non-leaf node is within the search area according to the pseudo-code of the “queryBoxBox” function described above.

At some point, the range query engine 514 finds a leaf node within the search area. Part of this operation includes determining a distance of an object represented by the leaf node to the center of the search area, which is step 1104. In some examples, this is provided as part of the queryBoxBox function described above. The range query engine 514 returns this data to the shader core 512. The shader core 512 evaluates this data against data characterizing already found objects and/or against the size of the search area. At step 1106, the shader core 512 determines whether to update (e.g., shrink) the search area. In an example, if the shader core 512 is searching for k nearest neighbors to a center point of a search area (where k can be any integer), then once the shader core 512 has found k nearest neighbors, it knows that the search area needs to be only as large as the farthest neighbor already found. Thus in this instance, the shader core 512 updates the search area and informs the range query engine 514 of this update.

At step 1108, the range query engine 514 continues traversal of the BVH. In some examples, this continuation involves searching through the remainder of the BVH not eliminated from consideration (e.g., due to a bounding volume being outside of the search area) and not yet already considered. In some examples, after step 1108, the range query engine 514 returns to step 1104, continuing traversal until all portions of the BVH have been eliminated from consideration or examined.

In some examples, a BVH used for the method 1100 is the same as the BVH used for ray tracing. In some examples, nodes in the BVH are marked as used for ray tracing and not search, used for searching and not ray tracing, or used for both. In any such example, where ray tracing is being performed, the ray tracing ignores nodes not marked as used for ray tracing and where search is being performed, the searching ignores nodes not marked as used for searching.

In some examples, the shader core 512 provides the search query to the range query engine 514 in the form of a processor instruction. The shader core 512 executes another instruction (e.g., “wait for results”), which causes the shader core 512 to wait for the search results, and resume when the search results are provided back to the shader core 512.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the command processor 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, BVH builder 501, shader core 512, or range query engine 514 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
traversing a bounding volume hierarchy (“BVH”) to identify an object within a search area in a scene;
determining a distance of the identified object to a center point of the search area;
updating or maintaining the search area based on the distance; and
continuing traversal of the BVH.

2. The method of claim 1, wherein traversing the BVH comprises eliminating nodes not included within the search area from consideration.

3. The method of claim 1, wherein traversing the BVH comprises traversing to nodes included within the search area.

4. The method of claim 1, wherein the distance is a Chebyshev distance.

5. The method of claim 1, wherein updating or maintaining the search area based on the distance comprises comparing the search area to the distance and, if the distance is smaller than the search area and a sufficient number of objects have been found in the search area, shrink the search area to align with the distance.

6. The method of claim 1, wherein traversing the BVH further includes traversing to an instance node.

7. The method of claim 6, wherein traversing to the instance node comprises performing an instance transform on extents of the search area.

8. The method of claim 1, wherein continuing traversal of the BVH comprises repeating the traversing, determining, and updating steps until a termination criterion is met.

9. The method of claim 8, wherein the termination criterion comprises a situation in which the BVH has been fully traversed.

10. A system comprising:
a memory configured to store at least a portion of a bounding volume hierarchy (“BVH”); and
a processor configured to perform operations comprising:
traversing the BVH to identify an object within a search area in a scene;
determining a distance of the identified object to a center point of the search area;
updating or maintaining the search area based on the distance; and
continuing traversal of the BVH.

11. The system of claim 10, wherein traversing the BVH comprises eliminating nodes not included within the search area from consideration.

12. The system of claim 10, wherein traversing the BVH comprises traversing to nodes included within the search area.

13. The system of claim 10, wherein the distance is a Chebyshev distance.

14. The system of claim 10, wherein updating or maintaining the search area based on the distance comprises comparing the search area to the distance and, if the distance is smaller than the search area and a sufficient number of objects have been found in the search area, shrink the search area to align with the distance.

15. The system of claim 10, wherein traversing the BVH further includes traversing to an instance node.

16. The system of claim 15, wherein traversing to the instance node comprises performing an instance transform on extents of the search area.

17. The system of claim 10, wherein continuing traversal of the BVH comprises repeating the traversing, determining, and updating steps until a termination criterion is met.

18. The system of claim 17, wherein the termination criterion comprises a situation in which the BVH has been fully traversed.

19. A system comprising:
a first digital circuit; and
a second digital circuit,
wherein the first digital circuit is configured to transmit a search query to the second digital circuit, and
the second digital circuit is configured to execute the search query by performing operations including:
traversing a bonding volume hierarchy (“BVH”) to identify an object within a search area in a scene;
determining a distance of the identified object to a center point of the search area;
updating or maintaining the search area based on the distance; and
continuing traversal of the BVH.

20. The system of claim 19, wherein traversing the BVH comprises eliminating nodes not included within the search area from consideration.
